(19) United States
(12) Patent Application Publication
(10) Pub. No.: US 2023/0282048 A1
(43) Pub. Date: Sep. 7, 2023

(54) ACCESS CARD WITH BUILT-IN USER INPUT DEVICE

(71) Applicant: Johnson Controls Tyco IP Holdings LLP, Milwaukee, WI (US)

(72) Inventors: Nilesh Ashok NAIK, Sawantawadi Maharastra (IN); Arun Parshuram Shinde, Mumbai Maharashtra (IN); Ankit PANCHAL, Mumbai Maharashtra (IN)

(21) Appl. No.: 17/687,327

(22) Filed: Mar. 4, 2022

(51) Int. Cl. G07C 9/22; G07C 9/28; G07C 9/27; G07C 9/00

(52) U.S. Cl. CPC G07C 9/22; G07C 9/28; G07C 9/27; G07C 9/00174; G07C 2009/00769

(57) ABSTRACT

The present aspects include an access card comprising a communication circuit configured to wirelessly communicate, in an activated state, a card identifier of the access card to an access point. The access card includes a switching circuit configured to switch between an open state and a closed state, wherein in the open state no power is supplied to the communication circuit, and in the closed state the power is supplied to the communication circuit to achieve the activated state. A user input device on the access card includes at least one input area configured to receive a user input of an identifier code, and the switching circuit is configured to switch to the open state in response to the identifier code matching a valid identifier code. Additional aspects include a method of use of the described access card.

### TECHNICAL FIELD

The present disclosure generally relates to an access card and a method of using an access card with a built in user input device.

### BACKGROUND

Access card entry systems which utilize an entry code generally require physical contact with a key pad utilized by multitude of people. Manual entry of a code on a key pad commonly used by a host of different people necessarily increases the spread of infection and disease as well as leads to damage to the key pad.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one example, the present aspects include an access card comprising a communication circuit configured to wirelessly communicate, in an activated state, a card identifier of the access card to an access point. The access card includes a switching circuit configured to switch between an open state and a closed state, wherein in the open state no power is supplied to the communication circuit, and in the closed state the power is supplied to the communication circuit to achieve the activated state. A user input device on the access card includes at least one input area configured to receive a user input of an identifier code, and the switching circuit is configured to switch to the open state in response to the identifier code matching a valid identifier code.

An example aspect includes a method of controlling access to an area, comprising receiving a user input of an identifier code in at least one input area of a user input device on an access card, wherein the access card is mobile. The method further includes operating a switching circuit on the access card to switch to a closed state in response to the identifier code matching a valid identifier code, wherein the switching circuit is configured to switch between the open state and a closed state, wherein in the open state no power is supplied by the switching circuit, and in the closed state the power is supplied by the switching circuit. Additionally, the method further includes activating a communication circuit, based on receiving the power from the switching circuit, to wirelessly communicate a card identifier of the access card to an access point.

Another example aspect includes an apparatus for controlling access to an area, comprising a memory and a processor in communication with the memory. The processor is configured to receive a user input of an identifier code in at least one input area of a user input device on an access card, wherein the access card is mobile. The processor is further configured to operate a switching circuit on the access card to switch to a closed state in response to the identifier code matching a valid identifier code, wherein the switching circuit is configured to switch between the open state and a closed state, wherein in the open state no power is supplied by the switching circuit, and in the closed state the power is supplied by the switching circuit. Additionally, the processor further configured to activate a communication circuit, based on receiving the power from the switching circuit, to wirelessly communicate a card identifier of the access card to an access point.

Another example aspect includes an apparatus for controlling access to an area, comprising means for receiving a user input of an identifier code in at least one input area of a user input device on an access card, wherein the access card is mobile. The apparatus further includes means for operating a switching circuit on the access card to switch to a closed state in response to the identifier code matching a valid identifier code, wherein the switching circuit is configured to switch between the open state and a closed state, wherein in the open state no power is supplied by the switching circuit, and in the closed state the power is supplied by the switching circuit. Additionally, the apparatus further includes means for activating a communication circuit, based on receiving the power from the switching circuit, to wirelessly communicate a card identifier of the access card to an access point.

Another example aspect includes a computer-readable medium of controlling access to an area, executable by a processor to receive a user input of an identifier code in at least one input area of a user input device on an access card, wherein the access card is mobile. The instructions are further executable to operate a switching circuit on the access card to switch to a closed state in response to the identifier code matching a valid identifier code, wherein the switching circuit is configured to switch between the open state and a closed state, wherein in the open state no power is supplied by the switching circuit, and in the closed state the power is supplied by the switching circuit. Additionally, the instructions are further executable to activate a communication circuit, based on receiving the power from the switching circuit, to wirelessly communicate a card identifier of the access card to an access point.

In one example implementation, which should not be considered limiting, the present aspects address one or more of the above noted issues with the typical access card entry systems by providing an access card with a built in pin pad to avoid the use of keypads touched frequently by multiple people numerous times.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram of an exemplary access card system.

FIG. 2 is schematic diagram of an example of internal components of the exemplary access card.

FIG. 3 is a schematic diagram of a wireless communication connection between an access card and access card reader.

FIG. 4 is a front view of one example of an access card.

FIG. 5 is a block diagram of an example of an architecture of the access card reader.

FIG. 6 is a flow diagram of an exemplary method of using an access card.

### DETAILED DESCRIPTION

Various aspects of the disclosure are now described with reference to the drawings, wherein like reference numerals are used to refer to elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below.

Aspects of the disclosure include an access card with a built-in input mechanism, such as for receiving a user input of an identifier code. The access card with a built-in input mechanism may provide one or more advantages over existing access cards, such as but not limited to increasing the security of the employees and the company, increasing the profits and business of company, aiding in professional growth of the company, stopping the entry of unauthorized persons, attracting customers by giving totally new features, and/or minimizing the spread of infection.

In an example implementation, the access card includes an input mechanism configured to receive a user input of an identifier code, such as a personal identification number (PIN). Further, the access card is configured to control transmission of a card identifier from the access card to an access point device based on whether or not a valid identifier code is received. In other words, in a security system, the card identifier is associated with an authorization to access to a user specific set of access points that control access to respective restricted areas. The access card of the present disclosure provides a secure, built-in mechanism for controlling whether the access card will communicate its credentials, e.g., the card identifier, to an access point device to allow a user to access a restricted area. Additionally, the presently disclosed access card having the described input mechanism provides an improved solution that avoids transmission of germs that often occur with access point devices that have fixed, common user interfaces that are used by all persons attempting to gain access to a restricted area.

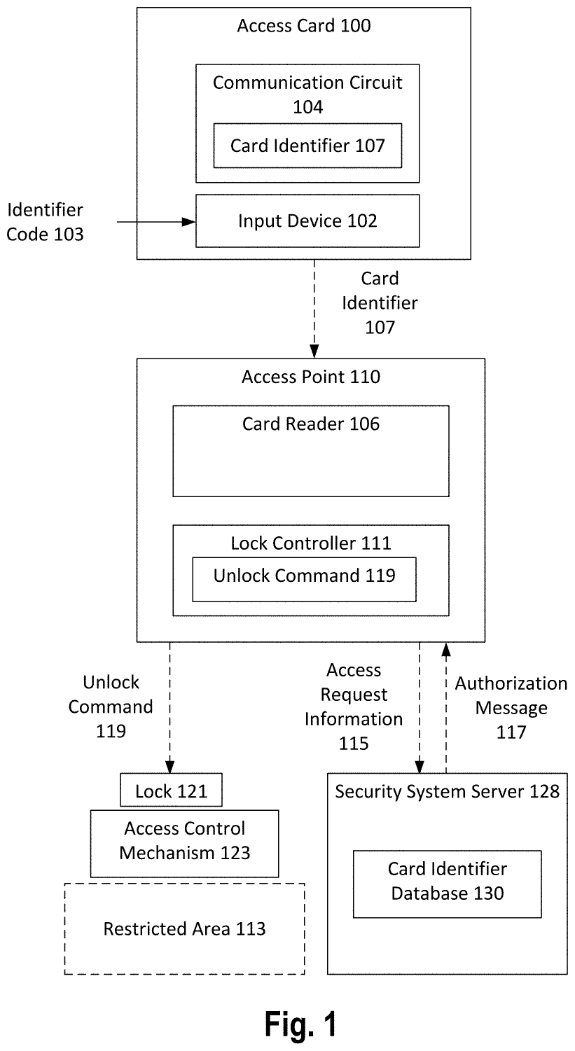

Referring to FIG. 1, in an exemplary aspect such as in a security system that controls access to an environment, an access card 100 includes a user input device 102 with at least one input area configured to receive a user input of an identifier code 103 that is used to unlock the access card 100 to control use of the access card 100 to provide access to a restricted area 113. The access card 100 further includes a communication circuit 104 configured to wirelessly communicate, based on receiving a valid identifier code 103, a card identifier 107 of the access card 100 to an access card reader 106 at an access point 110 that controls access to the restricted area 113. The card identifier 107 is associated, in a card identifier database 130 on a security system server 128 that controls the access point 110, with one or more authorizations to access to one or more access points 110 that control access to a corresponding one or more restricted areas 113. Consequently, the access point 110 communicates access request information 115 to the security system server 128 for authentication, and the security system server 128 may return an authorization message 117 that grants or denies access. In some examples, the access request information 115 may include the card identifier 107 (or a representation thereof) and, optionally, an identifier of the access point and/or other access card information. In some examples, the authorization message 117 includes an indicator with either a first value that represents authorization to access or a second value that represents a denial of access. Based on the authorization message 117 including an indication to allow access, a lock controller 111 associated with the access point 110 may transmit an unlock command 119 to a lock 121 of an access control mechanism 123 that variably restricts or allows access to the restricted area 113. Suitable examples of the access control mechanism 123 include, but are not limited to, a door or a gate that restrict access to the restricted area 113 when the lock 121 is in a locked state and that allow access to the restricted area 113 when the lock 121 is in an unlocked state. In this case, the unlock command 119 is configured to control the lock 121 to change from the locked state to the unlocked state. Thus, a user who enters a valid identifier code 103 into the input device 103 of the access card 100 can trigger the access card 100 to transmit the card identifier 107 to the access point 110, which in combination with the security system server 128 can determine if the card identifier 107 is associated with authorization to access the restricted area 113, and if so, unlock the access control mechanism 123 to allow the user to gain access. Alternatively, if a valid identifier code 103 is not received at the input device 103 of the access card 100, then the access card 100 will not be enabled to communicate with the access point 110 and access will not be granted.

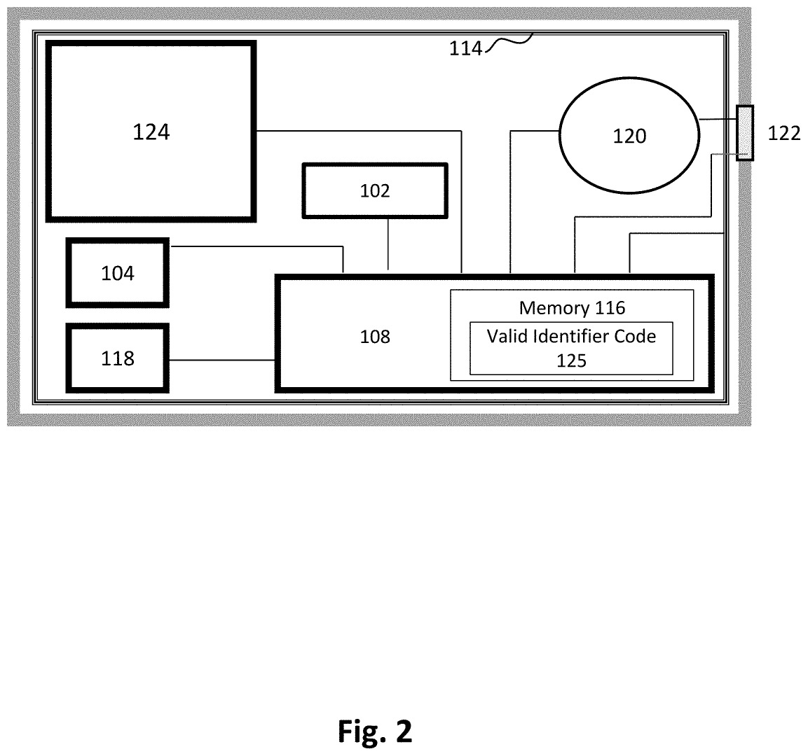

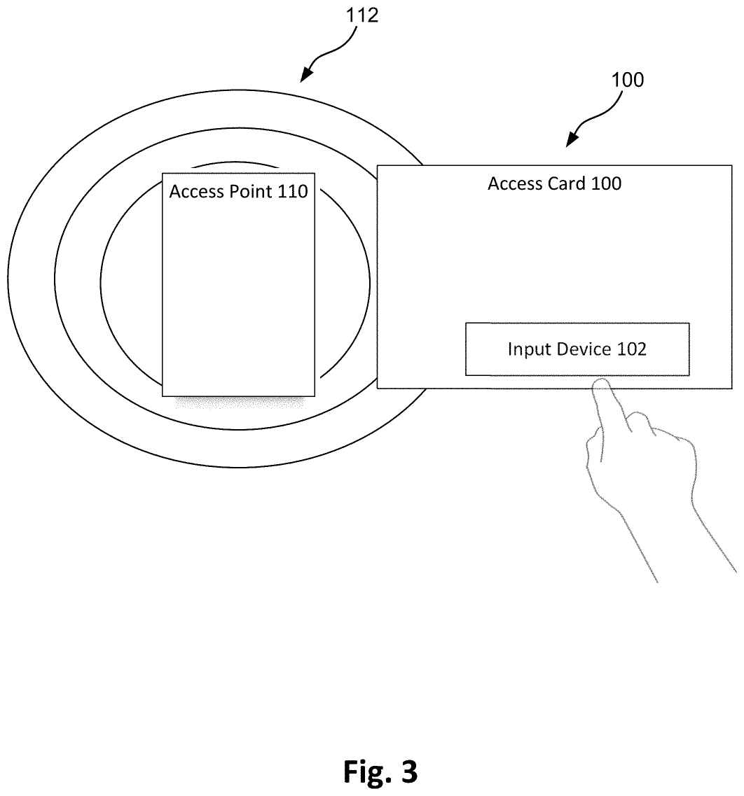

Referring to FIGS. 2 and 3, in an aspect, one example hardware implementation of the access card 100 includes the communication circuit 104 being controlled by a switching circuit 108 that is configured allow power to be supplied from a power coil 114, which may produce the power in the presence of an electromagnetic field 112 of the access point 110 (see FIG. 3). In particular, the switching circuit 108 is configured to supply power to the communication circuit 104 based on whether an identifier code matching a valid identifier code has been entered into the user input device 102. For example, the switching circuit 108 may include a microchip, a processor, a memory, a system on chip, and/or any other circuitry configured to perform the functions described herein. Also, for example, the communication circuit 104 may a microchip, a radio frequency identifier chip, a near field communications chip, a WiFi chip, a cellular communications chip, a processor, a memory, a system on chip, and/or any other circuitry configured to perform the functions described herein.

More specifically, in one example, a user approaches the access point 106 with the access card 100. When the access card 100 enters the electromagnetic field 112 generated by the access card reader 106, the power from the electromagnetic field 112 energizes the power coil 114 inside of the access card 100. In some aspects, such as when the access card 100 is powered solely by the electromagnetic field 112, the user will then input a identifier code 103 into the input device 102. For example, the input device 102 may be, but is not limited to, one or more virtual or physical buttons, a touch sensitive surface, and/or any other type of mechanism configured to receive information from the user. Further, for example, the identifier code 103 may be any type of data, such as but not limited to a personal identification code, numbers, letters, a pattern, or any combination thereof, that identifies the user to the access card 100. In any case, if the identifier code 103 matches a valid identifier code stored in a memory of the switching circuit 108, then the switching circuit 108 will supply power from the power coil 114 to the communication circuit 104 thereby activating the communication circuit 104 to communicate the access request information 115 to the access point 110. Alternatively, in some cases where the access card 100 includes a battery 120, then the user may enter the identifier code 103 into the input device 102 at any time upon approaching the access point 110. In an further alternative, in some cases where the access card includes the battery 120 and an on/off switch 118, the user may press the on/off switch 118 to connect the battery 120 to the switching circuit 108 and enable the processing of the identifier code 103. In this case, the user may turn off the on/off switch 118 to save power in the battery 120 when the access card 100 is not in use to gain access through the access point 110.

In an aspect, the switching circuit 108 is configured to switch between an open state and a closed state to control the communication circuit 104. When the switching circuit is in the open state, then no power is supplied to the communication circuit 104, e.g., the power coil 114 and/or the battery 120 are disconnected from the communication circuit 104. When the switching circuit 108 is in the closed state, then power is supplied to the communication circuit 104, e.g., from being connected to the power coil 114 and/or the battery 120, to achieve the activated state. For example, the switching circuit 108 includes a switch that remains open until the correct identifier code has been entered.

When the switching circuit 108 is in the closed state, the power coil 114 is configured to convert received energy into electrical power to supply the power to the communication circuit 104. The switching circuit 108 is configured to switch to the closed state in response to the identifier code matching a valid identifier code. The switching circuit 108 further includes a memory 116 configured to store at least the valid identifier code 125.

Alternatively if the identifier code 103 does not match the valid identifier code 125, the switching circuit 108 will maintain the open state and no power will be supplied to the communication circuit 104. In some cases, the user will then reenter another identifier code and when such identifier code matches the valid identifier code 125 stored in the memory 116, the switching circuit 108 will switch to the closed state wherein power will be supplied to the communication circuit 104 and the access card 100 will enter the activated state.

The memory 116 contains at least a valid identifier code. Further, in some cases, the memory 116 is further configured to store additional transaction information associated with the access attempt, such as but not limited to a time of requested access or an access point identifier, and/or logs for valid and invalid input (i.e., passcode or pin) entered by user on the access card at the time of requesting access.

As noted above, in some optional aspects, the access card 100 may include the battery 120 which will store power to be supplied to the switching circuit 108. In a further optional aspect, such as when the battery 120 is a rechargeable battery, the access card 100 includes a charging mechanism 122 configured to supply electric charge to the battery 120. For instance, the charging mechanism 122 may include, but is not limited to, an inductive charging device or a universal serial bus (USB) charging port.

In some optional aspects, the access card 100 may additionally include an indicator 124 configured to generate a plurality of different indications to identify a plurality of different access card states. The plurality of different access card states may include at least some of a card powered on state, a card powered off state, a valid identifier code received state, an invalid identifier code received state, a battery level state, a battery full state, or a batter low state. One example of the indicator 124 includes a lighting device configured to generate a light indication (e.g., different colors and/or patterns of light), however, other indicator devices or mechanisms may be used, such as but not limited to an audio device to generate a sound indication or a haptic device to generate a kinesthetic indication.

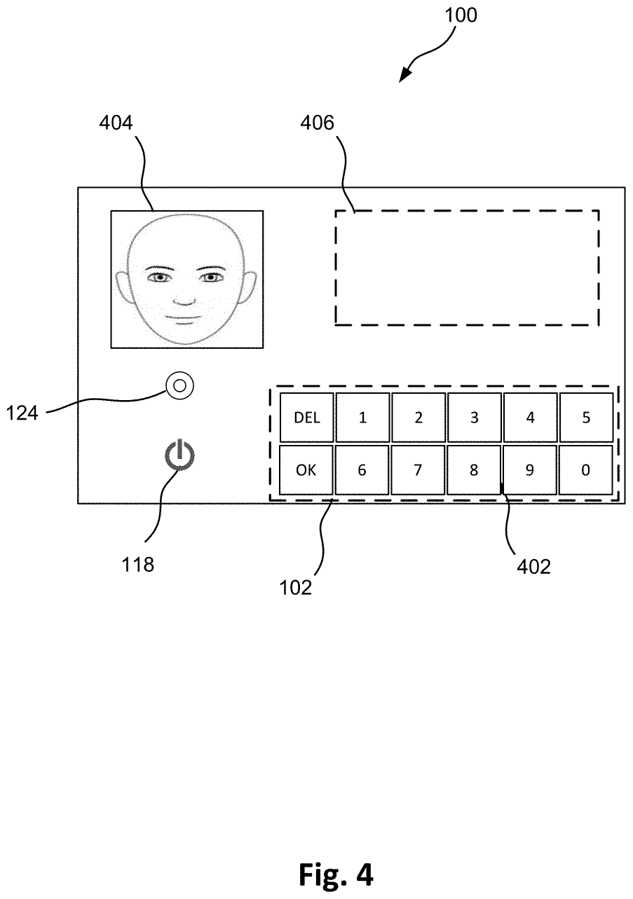

Referring to FIG. 4, one example of the access card 100 may include a front surface having the input device 102 in the form of physical buttons 402 and an on/off switch 118 connected to the battery 120 (not shown). Further, this example of the access card 100 may optionally include user identification information 404, such as but not limited to a photograph or a user name or an employee number, etc., to identify the owner of the access card 100. Alternatively or in addition, this example of the access card 100 may optionally include organization identification information 406, such as but not limited to a company name, a company logo, etc., to identify an organization, building or environment associated with the access card 100.

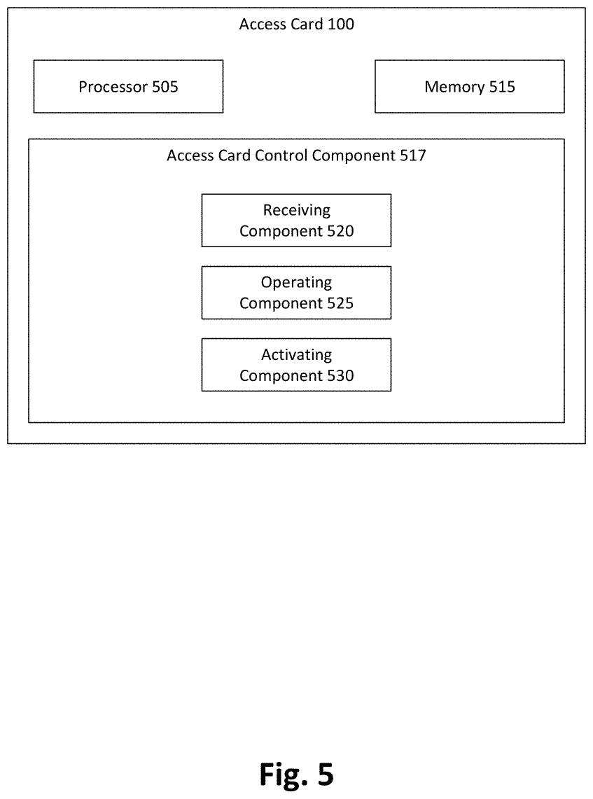

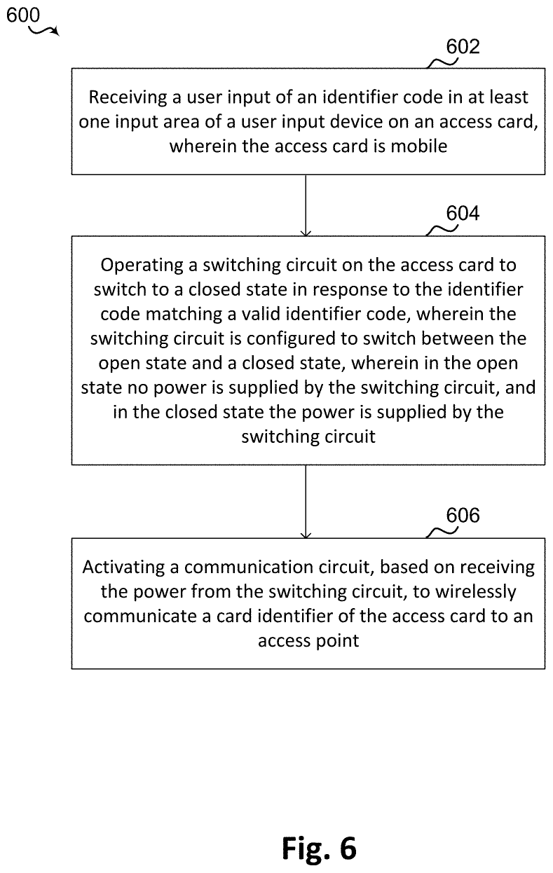

Referring to FIGS. 5 and 6, in operation, access card 100 may perform a method 600 of controlling access to an area, by such as via execution of access card control component 517 by processor 505 and/or memory 515. For example, access card control component 517, processor 505, and/or memory 515 may be implemented in one or any combination of the circuits described above with respect to the access card 100.

At block 602, the method 600 includes receiving a user input of an identifier code in at least one input area of a user input device on an access card, wherein the access card is mobile. For example, in an aspect, access card 100, processor 505, memory 515, access card control component 517, and/or receiving component 520 may be configured to or may comprise means for receiving a user input of an identifier code in at least one input area of a user input device on an access card, wherein the access card is mobile.

For example, the receiving at block 602 may include receiving an identifier code through the user input device 102 of the access card 100 as described above. There are multiple methods by which the receiving at block 602 may be performed. The methods of receiving a user input may include by are not limited to receiving a user input (e.g., pressing) of a physical button, receiving a user input (e.g., touch) of a virtual button on a touch-sensitive display, receiving a user input (e.g., touch and motion) in the form of a character and/or number on a touch-sensitive display, or receiving a user input of biometric info such as a fingerprint on fingerprint reader, an iris scan on iris reader, or a voice signal into a microphone.

Further, for example, the receiving at block 602 may be performed via the input device 102 physically located on the access card 100 because physical contact with a common reader or key pad located on or near an access point raises numerous issues. For example, one issue is that many users touching the same reader or key pad numerous times facilitates the spreading of infection and disease. Having a user perform any of the methods described above at a user input device 102 located on a personal access card 100 prevents multiple users from touching any one specific reader or key pad and in turn prevents the spread of infection and disease.

At block 604, the method 600 includes operating a switching circuit on the access card to switch to a closed state in response to the identifier code matching a valid identifier code, wherein the switching circuit is configured to switch between the open state and a closed state, wherein in the open state no power is supplied by the switching circuit, and in the closed state the power is supplied by the switching circuit. For example, in an aspect, access card 100, processor 505, memory 515, access card control component 517, and/or operating component 525 may be configured to or may comprise means for operating a switching circuit on the access card to switch to a closed state in response to the identifier code matching a valid identifier code, wherein the switching circuit is configured to switch between the open state and a closed state, wherein in the open state no power is supplied by the switching circuit, and in the closed state the power is supplied by the switching circuit.

For example, the operating of the switching circuit at block 604 may include a physical circuit wherein when the card is in the idle state, or not being used, a switch within the switching circuit is open and power is not supplied to the communication circuit 104 as discussed above. Further the switch will also remain in the open position when an incorrect code has been entered, before the user has started entering the code, and while the user is entering the code. When the used correctly enters the valid identified code the switch will move to the closed position, which completes the circuit and in turn supplies power to the communication circuit 104.

Further, for example, the operating of the switching circuit at block 604 may be performed in this manner as this is a simple and efficient way to allow an access card to be activated to access an access point when a correct identifier code has been entered. Additionally a simple switching circuit mechanism which closes in response to a correct identifier code being entered may easily be fit into a small access card which can be carried around by a user.

At block 606, the method 600 includes activating a communication circuit, based on receiving the power from the switching circuit, to wirelessly communicate a card identifier of the access card to an access point. For example, in an aspect, access card 100, processor 505, memory 515, access card control component 517, and/or activating component 530 may be configured to or may comprise means for activating a communication circuit, based on receiving the power from the switching circuit, to wirelessly communicate a card identifier of the access card to an access point.

For example, the activating of the communication circuit at block 606 may include activating a microchip, which contains the card number and any other unique data which it can communicate with an access card reader at an access point only after entering a correct or valid identifier code. This communication circuit microchip is connected to the switching circuit such that when the switching circuit is in the closed position, as discussed above, the microchip will receive power and will therefore be able to relay the stored information and in turn may allow the user access to the access point. A microchip is particularly advantageous as it can easily by connected to the switching circuit and can readily fit into a small access card, while still allowing the storage of all of the necessary information required to enter one or a multitude of access points.

In an aspect, the method 600 may further include configuring the switching circuit to maintain the open state in response to the identifier code not matching the valid identifier code. As discussed in more detail above this prevents a person who may find an access card from entering a restricted access point as they must also know the correct identifier code in order to cause the card to transmit the card identifier and gain access to the restricted access point. For example, if a person drops their access card another person would need to enter the correct identifier code for the switching circuit to enter the closed position and for the communication circuit to activate and allow access to an access point.

In an aspect, the method 600 may further include converting, by a power coil of the access card, received energy into electrical power to supply the power to the communication circuit when the switching circuit is in the closed state. In an example implementation, as mentioned above, the access card reader will generate a field, which will activate the power coil when the access card 100 is within range of the access card reader at the access point 110 and will allow the user to enter the identifier code.

In an aspect, the method 600 may further include generating, by an indicator on the access card, an indication that indicates an invalid identifier code has been received. As discussed in further detail above, the indicator may be used to show or otherwise output various states of the access card 100, such as on or off, as well as to relay whether a correct or incorrect identifier code has been entered.

In an aspect, the method 600 may further include receiving a user power input at a power switch to turn on the access card 100 prior to receiving the user input of the identifier code. In an aspect, this may include a power button, which the user may manually switch, however in alternative aspects the access card 100 may turn on automatically when the card is within range of the card read, the access card 100 may turn on in response to significant motion, e.g., as detected by an inertial measurement unit and communicated to the switching circuit 108, such as the user taking out the access card 100 to use it, or the access card may turn on when in the presence of a light source, e.g., as detected by a light sensor and communicated to the switching circuit 108.

In an aspect, the method 600 may further include generating, by an indicator, one of a plurality of different indications to identify one of a plurality of different access card states. In an aspect, the plurality of different access card states comprise at least two of a card powered on state, a card powered off state, a valid identifier code received state, an invalid identifier code received state, a battery level state, a battery full state, or a batter low state.

In an aspect, the method 600 may further include storing, by a memory in communication with the switching circuit, at least the valid identifier code. This will allow control logic in the switching circuit to move the switching circuit between the open and closed states based on whether the identifier code entered matches an identifier code stored within the memory. This allows for all of the necessary information to enter an access point 106 to be stored within the access card 100.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. An access card, comprising:
a communication circuit configured to wirelessly communicate, in an activated state, a card identifier of the access card to an access point;
a switching circuit configured to switch between an open state and a closed state, wherein in the open state no power is supplied to the communication circuit, and in the closed state the power is supplied to the communication circuit to achieve the activated state;
a user input device having at least one input area configured to receive a user input of an identifier code; and
wherein the switching circuit is configured to switch to the closed state in response to the identifier code matching a valid identifier code.

2. The access card of claim 1, wherein the switching circuit is configured to maintain the open state in response to the identifier code not matching the valid identifier code.

3. The access card of claim 1, further comprising a power coil configured to convert received energy into electrical power to supply the power to the communication circuit when the switching circuit is in the closed state.

4. The access card of claim 1, further comprising a power switch configured to turn the access card on and off.

5. The access card of claim 1, further comprising a battery configured to supply the power to the switching circuit.

6. The access card of claim 1, further comprising a charging mechanism configured to supply electric charge to the battery.

7. The access card of claim 6, wherein the charging mechanism comprises an inductive charging device or a universal serial bus (USB) charging port.

8. The access card of claim 1, further comprising an indicator configured to generate one of a plurality of different indications to identify one of a plurality of different access card states.

9. The access card of claim 8, wherein the plurality of different access card states comprise at least two of a card powered on state, a card powered off state, a valid identifier code received state, an invalid identifier code received state, a battery level state, a battery full state, or a battery low state.

10. The access card of claim 9, wherein the indicator comprises a lighting device.

11. The access card of claim 1, wherein the card identifier is associated with an authorization to access to a user specific set of access points.

12. The access card of claim 1, further comprising a memory in communication with the switching circuit and configured to store at least the valid identifier code.

13. The access card of claim 12, wherein the memory is further configured to store additional transaction information, wherein the additional transaction information includes at least one a time of requested access or an access point identifier.

14. A method of controlling access to an area, comprising:
receiving a user input of an identifier code in at least one input area of a user input device on an access card, wherein the access card is mobile;
operating a switching circuit on the access card to switch to a closed state in response to the identifier code matching a valid identifier code, wherein the switching circuit is configured to switch between the open state and a closed state, wherein in the open state no power is supplied by the switching circuit, and in the closed state the power is supplied by the switching circuit; and
activating a communication circuit, based on receiving the power from the switching circuit, to wirelessly communicate a card identifier of the access card to an access point.

15. The method of claim 14, further comprising configuring the switching circuit to maintain the closed state in response to the identifier code not matching the valid identifier code.

16. The method of claim 14, further comprising converting, by a power coil of the access card, received energy into electrical power to supply the power to the communication circuit when the switching circuit is in the closed state.

17. The method of claim 16, further comprising generating, by an indicator on the access card, an indication that indicates an invalid identifier code has been received.

18. The method of claim 14, further comprising receiving a user power input at a power switch to turn on the access card prior to receiving the user input of the identifier code.

19. The method of claim 14, further comprising generating, by an indicator, one of a plurality of different indications to identify one of a plurality of different access card states.

20. The method of claim 19, wherein the plurality of different access card states comprise at least two of a card powered on state, a card powered off state, a valid identifier code received state, an invalid identifier code received state, a battery level state, a battery full state, or a batter low state.

21. The method of claim 14, further comprising storing, by a memory in communication with the switching circuit, at least the valid identifier code.
